(19) United States
(12) Patent Application Publication
(10) Pub. No.: US 2026/0307030 A1
(43) Pub. Date: Oct. 8, 2026

(54) FUNCTION-ADDING ADAPTER FOR A MAGNETIC STIRRER, AND MAGNETIC STIRRER ARRANGEMENT

(71) Applicant: IKA-Werke GmbH & Co. KG, Staufen (DE)

(72) Inventor: Christian BABEL, Staufen (DE)

(73) Assignee: IKA-Werke GmbH & Co. KG, Staufen (DE)

(21) Appl. No.: 19/481,636

(22) PCT Filed: Apr. 16, 2024
(86) PCT No.: PCT/EP2024/060311

§ 371 Date: Nov. 5, 2025

(30) Foreign Application Priority Data
May 5, 2023 (DE) 10 2023 111 756.4

(51) Int. Cl. B01F 35/92; B01F 33/452; B01F 35/90; H05B 3/26

(52) U.S. Cl. CPC B01F 35/92; H05B 3/26; B01F 33/452; B01F 2035/99

(57) ABSTRACT

A function-adding adapter (1) for extending the functions of an existing magnetic stirrer (2), the function-adding adapter (1) including a heated-plate structure (3) with a heatable surface (4) on which at least one receptacle (5) can be placed.

### CROSS-REFERENCE TO RELATED APPLICATIONS

This application is a 371 National Phase of International Application No. PCT/EP2024/060311, filed Apr. 16, 2024, which claims priority from German Patent Application No. 10 2023 111 756.4, filed May 5, 2023, both of which are incorporated herein by reference as if fully set forth.

### TECHNICAL FIELD

The invention relates to a function adapter for extending the functionality of an existing magnetic stirrer. The invention furthermore relates to a magnetic stirrer arrangement, which comprises at least one magnetic stirrer and at least one such function adapter.

### BACKGROUND

In addition to magnetic stirrers which provide a wide range of functions and are therefore comparatively expensive, magnetic stirrers which have a simpler design, and are therefore initially cheaper to purchase, are also available. In this regard, there are magnetic stirrers which simply offer a single stirring point, for example, but otherwise have no further functions. Should the need for further functions arise at a later time, it has hitherto been necessary to replace such a single-point magnetic stirrer with a magnetic stirrer having a wider range of functions.

### SUMMARY

The object of the invention, therefore, is to provide a function adapter for extending the functionality of an existing magnetic stirrer, which enables an existing magnetic stirrer to be upgraded in a simple manner and avoids having to replace the existing magnetic stirrer with a more complex device.

To achieve the object, a function adapter for extending the functionality of an existing magnetic stirrer is proposed, which has one or more of the features disclosed herein. Accordingly, it is provided that the function adapter comprises a heating plate structure having a heatable supporting surface for at least one container.

With the function adapter according to the invention, it is possible for an existing magnetic stirrer, which is not itself equipped with a heating function, to be upgraded with a heating function and to therefore convert an existing magnetic stirrer into a magnetic stirrer with a heating plate.

In order to prevent the magnetic stirrer from being thermally overloaded when using the function adapter, it may be expedient if the heating plate structure has a supporting plate made of glass ceramic on which the supporting surface is formed, an insulation layer, a heating element, in particular a heating foil, and a heat conducting layer, in particular made of aluminum sheet. The heating element may be arranged between the supporting plate and the insulation layer, and the insulation layer may be arranged between the heating element and the heat conducting layer.

The heating element, in particular the heating foil, transfers heat not only in the direction of the supporting surface, but also in the opposite direction, in this case in the direction of a magnetic stirrer, which is equipped with the function adapter. The layer sequence of the heating plate structure prevents excessive heating of the existing magnetic stirrer arranged below the heating plate structure when using the function adapter.

The insulation layer, which is arranged below the heating element, in particular below the heating foil, reduces the heat transfer from the heating element of the heating plate structure to the magnetic stirrer located on the other side of the insulation layer in the usage position of the function adapter.

The additional heat conducting layer of the heating plate structure, which is arranged below the insulation layer as viewed from the heating element, enables the dissipation of heat which possibly passes through the insulation layer and therefore helps to protect the magnetic stirrer from thermal overload.

In one embodiment of the function adapter, a tolerance compensation layer may furthermore be arranged between the insulation layer and the heat conducting layer. The tolerance compensation layer enables reliable contact between the insulation layer and the heat conducting layer and may furthermore have an additional insulating effect. By way of example, a temperature-resistant fiber mat may be used as the tolerance compensation layer.

For reliable heat dissipation, and therefore to protect a magnetic stirrer equipped with the function adapter as reliably as possible, it may be advantageous if the heating plate structure has a heat conducting profile. The heat conducting profile may be made of a thermally conductive material, for example aluminum. The heat conducting profile may be connected to the heat conducting layer, so that heat absorbed by the heat conducting layer may be transferred to the heat conducting profile via the connection to the heat conducting profile. In particular, if the heat conducting profile has a large volume and/or a large thermal capacity compared to the heat conducting layer, it is possible for larger quantities of heat to be transferred to the heat conducting profile and thus kept away from a magnetic stirrer which is equipped with the function adapter. The heat conducting profile here may serve as a heat sink of the heating plate structure.

In one embodiment of the heat conducting profile, this is formed as a closed circumferential profile. The heat conducting profile may be frame-shaped and/or it may have, for example, a heat-dissipating design. By way of example, for a heat-dissipating design, cooling fins and/or channels and/or openings and/or bores and/or breaks and/or recesses in the heat-conducting profile may be provided, which may increase the surface area of the heat conducting profile and thereby improve the ability of the heat conducting profile to release heat to the environment. Furthermore, it is possible that the heat conducting profile forms at least part of the outer contour of the heating plate structure. In this way, heat introduced into the heat conducting profile may be released to the environment via the outer side of the heat conducting profile. This results in particularly efficient temperature management of the heating plate structure and therefore in particularly efficient protection against thermal overload for the magnetic stirrer equipped with the function adapter. The heat conducting profile may act as a heat exchanger here.

In a particularly advantageous embodiment of the function adapter, it is provided that the supporting plate is bonded to the heat conducting profile. The supporting plate may be connected to the heat conducting profile, for example, by a temperature-resistant, preferably double-sided, adhesive tape, by a temperature-resistant adhesive and/or by temperature-resistant silicone. In this way, a particularly compact design and simple production of the heating plate structure of the function adapter is possible. Separate fastening means, such as clamps or screws, for fixing the supporting plate on the heat conducting profile may then be omitted.

The heating element of the heating plate structure may be arranged and/or designed such that only an inner region of the supporting plate, on which the supporting surface is formed, is heated. If a connection between the supporting plate and the heat conducting profile is established via an adhesive connection in an edge region of the supporting plate, which surrounds the supporting surface on the supporting plate in a circumferentially closed manner, for example, the adhesive connection between the supporting plate and the heat conducting profile, namely the preferably double-sided, temperature-resistant adhesive tape, may be protected from thermal overload.

In a preferred embodiment of the function adapter, it is provided that a heatable surface of the heating element is spaced apart from the heat conducting profile. Direct contact between the heatable surface and the heat conducting profile is thus avoided. In this way, the direct input of heat into the heat conducting profile may be avoided.

The heatable surface may be surrounded by an unheated edge region of the heating element. The non-heatable edge region may be made from a mica material with good thermal insulation properties. Due to the non-heatable edge region of the heating element, the input of heat into the heat conducting profile directly from the plane of the heating plate structure in which the heating element is arranged may be at least reduced or at least substantially avoided. If too much heat is introduced into the heat conducting profile in this plane, this may have a negative effect on the efficiency of the heat-exchanger function of the heat conducting profile.

By way of example, heating wires or heating paths may be arranged within the heatable surface. The heating element may have at least one material-free cutout at the edge. The aim of this is to avoid direct contact between the heating element and the heat conducting profile. The at least one material-free cutout at the edge may adjoin the heatable surface of the heating element.

In one embodiment of the function adapter, it may be provided that the heating element has contact surfaces only in its, in particular four, corner regions. The contact surfaces may be made from mica material. In the usage position, the heating element may contact the heat conducting profile via the contact surfaces. The previously mentioned material-free cutouts may then be formed between the contact surfaces of the heating element which are formed in the corner regions. A contact area between the heating element and the heat conducting profile is therefore minimized. Furthermore, the four contact surfaces formed in the corner regions facilitate a centering of the heatable surface of the heating element in the interior of the heating plate structure.

The heat conducting profile may have a geometry such that a projection of the heat conducting profile onto the supporting plate surrounds the supporting surface for a container in a closed manner, which supporting surface is formed on the supporting plate.

By way of example, the insulation layer may be made from a microporous insulation material, from polyurethane, from rock wool and/or from glass wool.

As previously indicated, the heat conducting profile may have a frame-shaped design. The heat conducting profile may furthermore define an interior space in which the heating element and/or the insulation layer and/or the tolerance compensation layer of the heating plate structure are arranged. The heat conducting profile may then serve, on the one hand, to receive the aforementioned layers of the heating plate structure and to absorb heat from the heating element which is not transferred to the supporting plate. The heat conducting profile may be arranged between the supporting plate and the heat conducting layer.

The heating plate structure may furthermore have a heat shielding layer, in particular made of stainless steel sheet. The heat shielding layer may be arranged on the heat conducting layer. The heat shielding layer may be arranged, in particular, on a side of the heat conducting layer which faces away from the heating element and/or the heat conducting profile. The heat shielding layer may serve as additional thermal protection against thermal overload for the magnetic stirrer equipped with the function adapter.

The use of the heat shielding layer, in particular made of stainless steel, is advantageous, for example, if the heat conducting layer is interrupted in places or reduced in terms of its layer thickness. This may be the case in order to minimize a magnetically shielding effect of the heat conducting layer, which would impair a magnetic coupling between a stirring point of the magnetic stirrer which is equipped with the function adapter, and/or between a stirring point which may also have the function adapter, and a magnetic follower such as a magnetic stirring bar. The heat shielding layer then serves as a further barrier against heat which may pass through the heat conducting layer more easily at these points.

In one embodiment of the function adapter, the heating plate structure has a carrier plate on an underside facing away from the supporting plate. By way of example, the carrier plate may be made from plastic and may form a termination of the heating plate structure. Forming the carrier plate from plastic may furthermore provide an additional insulating effect and may thus contribute to the thermal protection of the magnetic stirrer equipped with the function adapter.

The carrier plate may be connected, for example screwed, to the heat conducting profile of the heating plate structure. A screw connection between the carrier plate and the heat conducting profile may press the individual layers of the heating plate structure against each other and also against the previously mentioned tolerance compensation layer.

The function adapter may have at least one light source, for example an LED, in particular an RGB LED, for generating a light display on the supporting plate. Via such an LED, it is then possible to generate a light display for the status display on the supporting plate, for example adjacent to the supporting surface on the supporting plate.

In one embodiment of the function adapter, it is provided that a light source is arranged on the heating plate structure, for example on the previously mentioned carrier plate of the heating plate structure. The light source is preferably oriented such that it radiates in the direction of the supporting plate. To generate a light display on the upper side of the supporting plate, this may be at least partially transparent or translucent. The supporting plate may then be irradiated from below in order to generate the desired light display on the upper side of the supporting plate.

For each light source, the heating plate structure may have a respective screen against lateral light radiation, for example on the carrier plate. The screen may be used to minimize or even completely prevent the lateral emission of light through a gap between the carrier plate and the heat conducting profile. A gap between the carrier plate and the heat conducting profile may be sealed in a light-tight manner in order to avoid a situation in which light is emitted through a gap. The screen(s) may act as reflectors and, for this purpose, may be provided with a reflective coating, in particular with a highly reflective, for example white, lacquer.

In one embodiment, the function adapter may have multiple light sources for generating a light display. These multiple light sources may be, for example, LEDs, preferably RGB LEDs and/or pixel LEDs, and/or they may be connected to each other via a data bus. The use of pixel LEDs as light sources which can be connected to each other via a data bus simplifies the interconnection of the light sources and further facilitates targeted activation of the light sources for generating a particularly meaningful light display on the supporting plate of the function adapter. By way of example, multiple light sources may be arranged on a printed circuit board.

In particular, if the at least one light source is arranged on the previously mentioned carrier plate of the heating plate structure, it may be expedient if the heat conducting profile has at least one light opening through which light may be conducted from the at least one light source to and through the preferably at least partially transparent or translucent supporting plate. The heat conducting profile then thermally separates the at least one light source from the heating element of the heating plate structure and simultaneously enables the generation of the previously described light display on the supporting plate.

In one embodiment of the function adapter, it is provided that the heat conducting profile has a plurality of such light openings, preferably annularly surrounding the supporting surface. In this way it is possible to generate a light display which annularly surrounds the supporting surface on the supporting plate of the function adapter.

The at least one light opening in the heat conducting profile may form a light segment of the light display. The heat conducting profile may reliably protect the at least one light source from thermal overload caused by the heat emitted by the heating element of the heating plate structure. The heat conducting profile therefore serves as a spacer between the at least one light source and the heating element and may moreover absorb and dissipate heat generated by the at least one light source.

The formation of an optically appealing light display on the supporting plate may be facilitated if the supporting plate is designed to be at least partially transparent or translucent and/or knob-free and/or has a glass finish and/or a filter and/or shading, at least in the region of the at least one light opening. In particular, the use of a glass finish, a filter and/or shading may facilitate the formation of a uniform and therefore particularly appealing light display on the surface of the supporting plate.

A seal may be arranged between the supporting plate and the heat conducting profile. The seal may prevent moisture from entering. The seal may have at least one light passage segment, which limits an effective light-emission cross section of the at least one light opening of the heat conducting profile. The seal may therefore act as an aperture in order to give the light segment generated with the aid of the light opening the desired shape in a particularly simple manner.

The seal may furthermore have a, preferably closed, circumferential sealing lip, which is formed on a side of the seal which faces the supporting plate of the heating plate structure in the usage position of the seal. The sealing lip may facilitate the sealing effect of the seal. The seal may preferably be made from rubber or silicone.

The function adapter may be designed as an attachment to be seated on, and/or slipped over, a supporting surface of a magnetic stirrer. Furthermore, the function adapter may have a housing with a receiving space in which an existing magnetic stirrer is arranged when the function adapter is positioned in the usage position on the magnetic stirrer.

The function adapter may furthermore have at least one fixing means, in particular in the previously mentioned receiving space, for fixing the function adapter on a magnetic stirrer. By way of example, the at least one fixing means may be an elastic clamping element and/or it may be made from rubber.

A depth of the receiving space may correspond to a height of the existing magnetic stirrer or it may be greater than the height of the existing magnetic stirrer. The function adapter may then be slipped over an existing magnetic stirrer like a hood and may then reliably protect the magnetic stirrer from potentially aggressive environmental influences.

In one embodiment of the function adapter, a depth of the receiving space may be smaller than a height of the existing magnetic stirrer; for example, it may correspond to half the height of the magnetic stirrer.

The function adapter may furthermore have at least one connection interface, for example in the previously mentioned receiving space. It is possible to transmit current and/or control signals and/or data to the magnetic stirrer, or to retrieve these from the magnetic stirrer, via such a connection interface. A magnetic stirrer equipped with the function adapter may therefore be supplied with current, data and/or signals via the function adapter. A separate connection of the magnetic stirrer is then unnecessary.

To supply power to the magnetic stirrer, the function adapter may itself have a connection via which the function adapter may be connected to a current source and/or to a control unit.

The function adapter may have, at least on an outer side, at least one coupling interface for mechanical and/or electrical connection and/or for the data connection of the function adapter to a control unit and/or to another such function adapter. In this way, it is possible to connect the function adapter to a control unit or to form a group comprising multiple function adapters. The entire group may then be supplied with current, data and/or control signals and controlled via a coupling interface of a function adapter.

In one embodiment of the function adapter, such a coupling interface is present on at least two different outer sides in each case.

Multiple function adapters may be connected either directly to each other via their coupling interfaces or via cable connections. Cables are then used here to connect the coupling interfaces of the function adapters to each other. In this way, a group of function adapters and magnetic stirrers equipped therewith may be provided, which can then be activated via a central control unit.

In one embodiment of the function adapter, it is provided for this function adapter to have at least one stirring point for driving a magnetic follower, in particular a magnetic stirring bar. The at least one stirring point of the function adapter may be driven via a stirring point of an existing magnetic stirrer, which is to be equipped with the function adapter.

The function adapter may have, as a stirring point, at least one rotatably mounted output and a magnetic coupling element, which can be magnetically coupled to a stirring drive of an existing magnetic stirrer and via which the at least one output may be driven at least indirectly. A rotational movement generated by a stirrer drive of the existing magnetic stirrer may be introduced into the function adapter via the magnetic coupling element.

The at least one output of the function adapter may have at least one magnet, in particular at least two magnets, for magnetic coupling to a follower, for example to a magnetic stirring bar.

The at least one magnet of the drive is preferably a rare-earth magnet. Rare-earth magnets are particularly powerful and are suitable for producing a magnetic coupling to a follower, for example to a magnetic stirring bar, even over a somewhat greater distance. The heating plate structure, which minimizes heat dissipation in the direction contrary to the supporting plate, and therefore in the direction of the output, prevents the at least one magnet of the output from becoming overheated, for example from reaching a temperature of more than 80° C. At more than 80° C., rare-earth magnets may become unstable and lose their magnetic effect. The heating plate structure may therefore facilitate the use of a rare-earth magnet on the function adapter.

In a preferred embodiment of the function adapter, which enables the functionality of an existing magnetic stirrer to be extended not only by a heating function, it is provided that the function adapter has at least two rotatably mounted outputs as stirring points. The function adapter may therefore be used to convert an existing single-point magnetic stirrer into a multi-point magnetic stirrer.

The magnetic coupling element of the function adapter may then be connected to the at least two outputs of the function adapter via a distributor, for example via a belt and/or a gear. It is thus possible to distribute a rotational movement introduced into the function adapter via the magnetic coupling element to at least two rotatably mounted outputs of the function adapter and, therefore, to ultimately realize at least two stirring points on the function adapter.

In one embodiment of the function adapter, it is provided that the function adapter has a, preferably, central stirring point, which is surrounded by at least two stirring points. By way of example, a larger-volume stirring container may be placed on this one, preferably central, stirring point and a magnetic follower arranged therein may be driven for mixing liquid located in the stirring container. The function adapter may therefore be used either with multiple smaller stirring containers placed on the individual stirring points or with only a single, larger stirring container.

In one embodiment of the function adapter, the heat conducting layer of the heating plate structure may be interrupted and/or filled with a non-magnetically-shielding inlay, for example a stainless steel inlay, and/or reduced in terms of its layer thickness, for example from 2 mm to 0.5 mm or 0.4 mm or 0.3 mm, in at least one region, in particular at least in the region of the at least one stirring point of the function adapter or in the region which adjoins a stirring point of a magnetic stirrer in the usage position of the function adapter. Magnetic shielding between the respective stirring point and a magnetic follower, such as a magnetic stirring bar, may therefore be minimized or completely avoided.

The function adapter may also be operated without a magnetic stirrer if required and then acts as a laboratory heating plate.

To achieve the object, a magnetic stirrer arrangement is also proposed, which comprises at least one magnetic stirrer and at least one function adapter according to one of the claims directed to such. The function adapter may then be placed over the magnetic stirrer in the usage position. The magnetic stirrer may then be arranged inside the function adapter so that it is no longer visible, even from the outside. In this case, the function adapter acts like a hood, under which the magnetic stirrer is then arranged such that is protected from external influences.

### BRIEF DESCRIPTION OF THE DRAWINGS

The invention will be described in more detail below with the aid of exemplary embodiments, although it is not limited to these exemplary embodiments. Further exemplary embodiments are derived by combining the features of individual or multiple claims with one another and/or by combining individual or multiple features of the exemplary embodiments. In the figures:

FIG. 1 shows a perspective view from below of a function adapter with a receiving space for a magnetic stirrer, which is also shown, so that the function adapter may be placed over the magnetic stirrer in the usage position and the magnetic stirrer may be arranged in the receiving space,

FIG. 2 shows a perspective view from below of the function adapter shown in FIG. 1 in its usage position on the magnetic stirrer, wherein the magnetic stirrer is arranged in the receiving space of the function adapter,

FIG. 3 shows a view from below of the arrangement of FIG. 2, wherein fixing means in the form of rubber knobs can be seen in the receiving space of the function adapter, which fixing means clamp the magnetic stirrer within the receiving space and thus fix the function adapter on the magnetic stirrer,

FIG. 4 shows an exploded representation of the heating plate structure for illustrating the components and the layer sequence of the heating plate structure,

FIG. 5 shows a sectional side view of the heating plate structure with the aluminum frame-shaped heat conducting profile from FIG. 4 for illustrating light openings formed in the heat conducting profile, which enable the generation of a light display on the upper side of the supporting plate of the heating plate structure,

FIG. 6 shows a perspective representation of a further embodiment of the function adapter, which not only upgrades an existing single-point magnetic stirrer with a heating function, but also converts it into a multi-point magnetic stirrer, wherein, in this representation, the heating plate structure is shown as transparent/faded out for better clarity and the function adapter below the heating plate structure has five individual stirring points which are drivingly connected to each other via belts,

FIG. 7 shows a sectional side view of the function adapter shown in FIG. 6 in the usage position on a single-point magnetic stirrer,

FIG. 8 shows a sectional side view of a further function adapter in the usage position on a single-point magnetic stirrer, wherein the function adapter has merely a heating plate structure and therefore upgrades the existing single-point magnetic stirrer merely with the heating function,

FIG. 9 shows a perspective representation of a function adapter with a control unit coupled thereto, via which control unit the function adapter and, in particular, its heating function, but also the magnetic stirrer equipped with the function adapter, can be activated,

FIG. 10 shows a perspective representation of three function adapters coupled via their housing-side coupling interfaces to form a group, wherein the coupling interfaces enable a current and/or signal transmission between the function adapters and the magnetic stirrers equipped therewith, so that the entire group can be activated via a single control unit,

FIG. 11 shows a group of magnetic stirrers equipped with function adapters, wherein the function adapters are connected to each other via cables, and

FIG. 12 shows a plan view of a function adapter for illustrating five stirring points of the function adapter and a light display on the supporting surface of the function adapter.

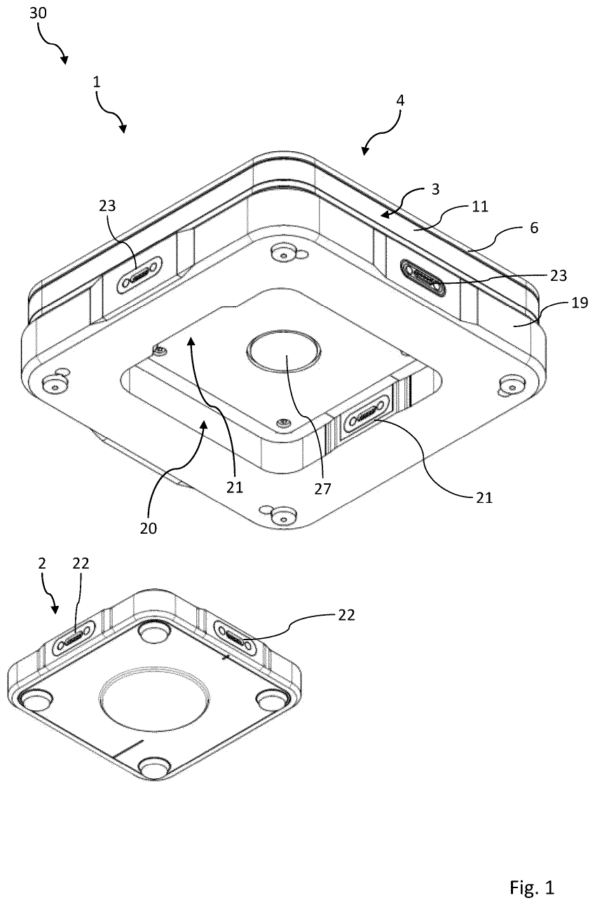

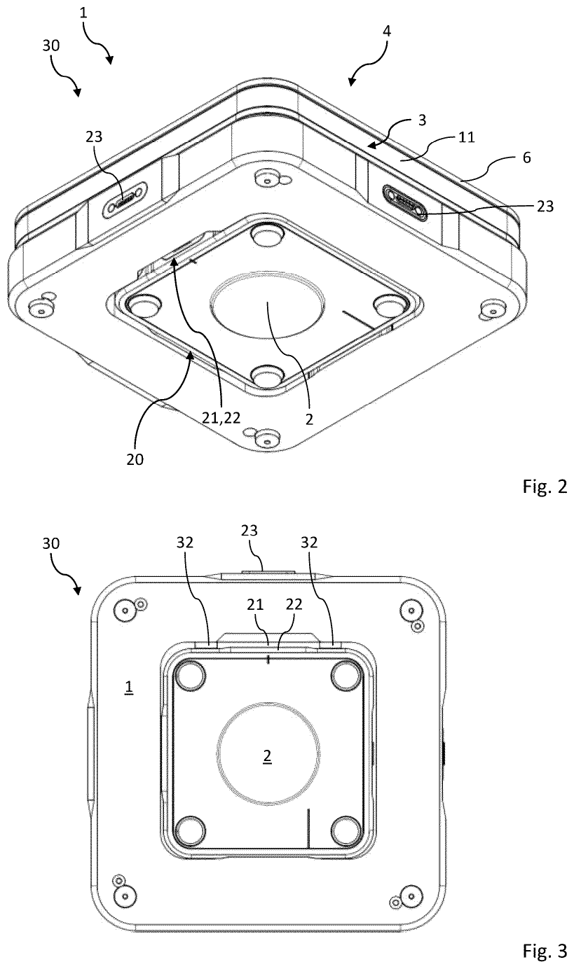

### DETAILED DESCRIPTION

In the description below of various embodiments of the invention, elements that correspond in terms of their function are denoted by corresponding reference signs, even if there is a difference in their design or form.

All figures show at least some of the function adapters denoted as a whole by 1, which serve for extending the functionality of an existing magnetic stirrer 2.

Each function adapter 1 comprises a heating plate structure 3 with a heatable supporting surface 4 for at least one container 5. The function adapters 1 shown in the figures correspond in terms of the heating plate structure 3.

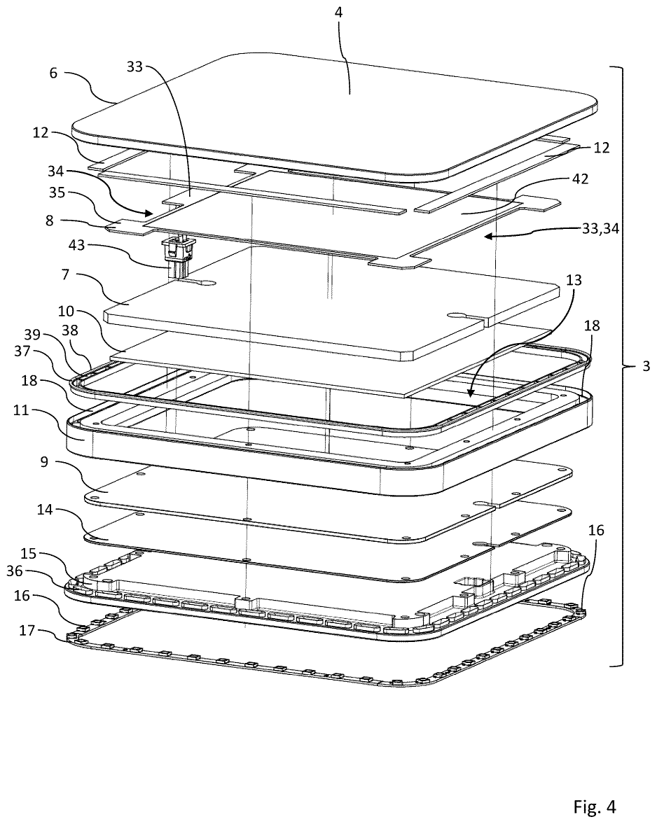

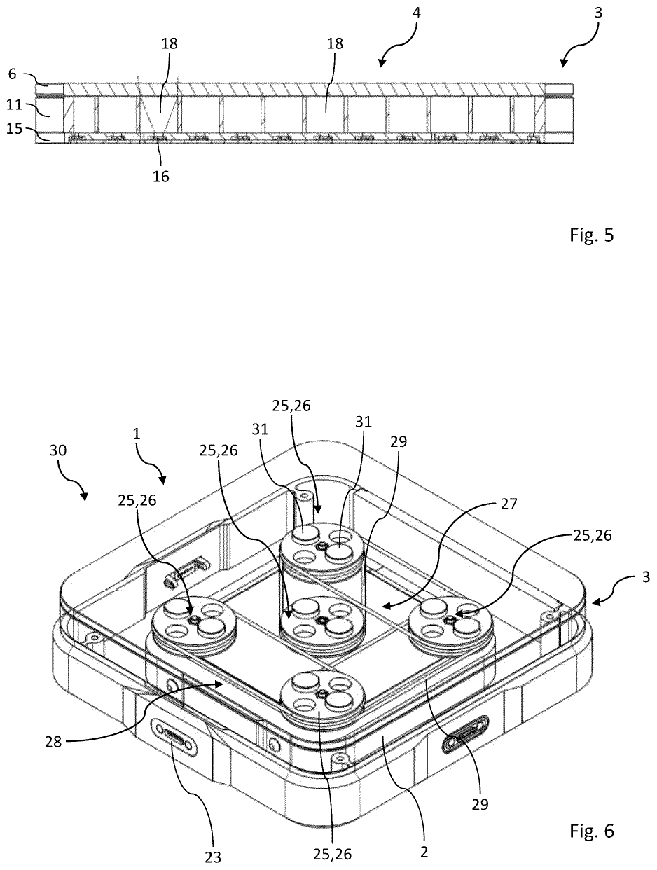

The heating plate structure 3 comprises a supporting plate 6 made of glass ceramic, which is at least partially transparent or translucent, at least at the edge, and on which the supporting surface 4 is formed. Furthermore, the heating plate structure 3, as illustrated in FIG. 4, comprises an insulation layer 7, a heating element 8 in the form of a heating foil and a heat conducting layer 9, which is made from an aluminum sheet.

The heating element 8 is arranged below the supporting plate 6 and therefore between the supporting plate 6 and the insulation layer 7. The insulation layer 7 is in turn arranged below the heating element 8 and therefore between the heating element 8 and the heat conducting layer 9. Between the insulation layer 7 and the heat conducting layer 9, the heating plate structure 3 comprises a tolerance compensation layer 10, which is made from a temperature-resistant fiber mat. The heating plate structure 3 furthermore comprises a heat conducting profile 11, which is made from aluminum and serves as a heat sink. The heat conducting profile 11 is connected to the heat conducting layer 9 so as to facilitate the heat transfer from the heat conducting layer 9 to the heat conducting profile 11.

FIG. 4 shows that the heat conducting profile 11 is a closed circumferential, frame-shaped profile and forms part of the outer contour of the heating plate structure 3.

According to FIG. 4, the heat conducting profile 11 is arranged between the supporting plate 6 and the heat conducting layer 9 of the heating plate structure 3. The supporting plate 6 of the heating plate structure 3 is connected, namely bonded, to the heat conducting profile 11 by a temperature-resistant double-sided adhesive tape 12, which is shown below the supporting plate 6 in FIG. 4. The adhesive tape 12 is arranged in an edge region of the supporting plate 6 and on an underside of the supporting plate 6. The supporting surface 4 on the supporting plate 6 is arranged within a projection of the adhesive tape 12 onto the supporting plate 6.

The heating element 8 is arranged and/or designed such that only an inner region of the supporting plate 6, on which the supporting surface 4 is formed, is heated. In this way, the adhesive connection between the supporting plate 6 made of glass ceramic and the heat conducting profile 11 made of aluminum is protected from thermal overload.

The insulation layer 7 of the heating plate structure 3 is made from a microporous insulation material.

As previously mentioned, the heat conducting profile 11 has a frame-shaped design. The heat conducting profile 11 comprises an interior space 13 in which the heating element 8, namely the heating foil, and the insulation layer 7 as well as the tolerance compensation layer 10 are arranged. The heating plate structure 3 furthermore comprises a heat shielding layer 14, which is made from stainless steel sheet and which is arranged on the heat conducting layer 9. The heat shielding layer 14 is arranged on an underside of the heat conducting layer 9, which faces away from the heating element 8 and also from the heat conducting profile 11.

On an underside of the heating plate structure 3 which faces away from the supporting plate 6, this heating plate structure has a carrier plate 15 made of plastic. The carrier plate 15 therefore forms the lower termination of the heating plate structure 3. The carrier plate 15 may be screwed to the heat conducting profile 11, for example.

FIG. 4 shows that the function adapter 1 has a series of light sources 16, which serve to generate a light display 41 on the supporting plate 6 of the heating plate structure 3 and are arranged on a PCB strip. By way of example, the status of the magnetic stirrer 2 and/or the function adapter 1—for example, a temperature of the supporting surface 4—may be output via the light display 41.

The light sources 16 are RGB LEDs, namely so-called pixel LEDs, which are arranged on the heating plate structure 3, namely on the carrier plate 15 of the heating plate structure 3. The pixel LEDs are connected to each other via a data bus 17. This enables a simple interconnection of the light sources 16 and the generation of a particularly appealing light display for displaying the status of the function adapter 1 and the magnetic stirrer 2, equipped therewith, on the upper side of the at least partially transparent or translucent supporting plate 6.

So that the light emitted by the light sources 16 for the purpose of generating the light display may be conducted to and through the supporting plate 6, the heat conducting profile 11 has a series of light openings 18. The light emitted by the light sources 16 may be conducted to and ultimately through the supporting plate 6 from below via the light openings 18, which supporting plate is at least partially transparent or translucent, at least in this region. FIG. 4 illustrates that the heat conducting profile 11 has a plurality of such light openings 18 annularly surrounding the supporting surface 4 on the supporting plate 6. By way of example, the light openings 18 may extend conically from bottom to top or from top to bottom. Each light opening 18 enables the formation of a light segment on the upper side of the glass ceramic supporting plate 6 of the heating plate structure 3.

In the region of the light openings 18, the supporting plate 6 is designed to be at least partially transparent or translucent and knob-free and/or is provided with a glass finish and/or a filter and/or a shading in order to facilitate the formation of individual light segments of a light display to be generated on the upper side of the supporting plate 6.

The function adapters 1 shown in the figures are designed as an attachment to be seated on a supporting surface of an existing magnetic stirrer 2 and may be slipped over an existing magnetic stirrer 2 like a hood.

Each function adapter 1 has a housing 19 with a receiving space 20, in which an existing magnetic stirrer 2 is arranged when the function adapter 1 is positioned in the usage position on the magnetic stirrer 2. FIG. 3 illustrates that the function adapter 1 has, in its receiving space 20, two fixing means 32 in the form of elastic clamping elements made of rubber for fixing the function adapter 1 on a magnetic stirrer 2.

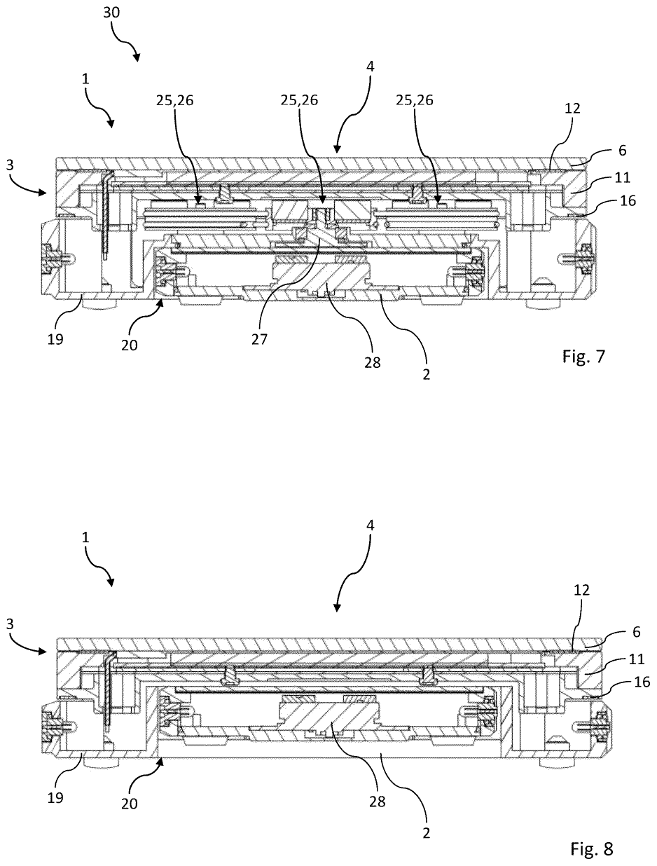

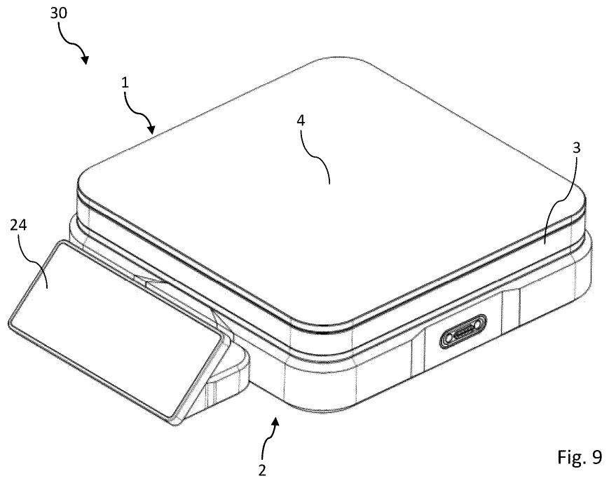

The sectional representations of FIGS. 7 and 8 show that a depth of the receiving space 20 corresponds at least to a height of the existing magnetic stirrer 2 or that-as FIG. 8 shows—it is greater than the height of the existing magnetic stirrer 2.

The function adapter 1 has, in its receiving space 20 for an existing magnetic stirrer 2, two connection interfaces 21, via which current and/or control signals and/or data can be transferred between the function adapter 1 and the magnetic stirrer.

In this way, it is possible to supply a magnetic stirrer 2 arranged in the receiving space 20 with current, data and/or control signals, or to transmit current, data and/or control signals to a further function adapter which may be connected to the function adapter 1, via these connection interfaces 21.

The connection interfaces 21 in the receiving space 20 of the function adapter 1 are adapted to the corresponding connection interfaces 22 on the outer sides of the existing magnetic stirrer 2.

On four different outer sides, the function adapter 1 furthermore comprises a coupling interface 23 in each case for mechanical and/or electrical connection and/or for the data connection of the function adapter 1 to a control unit 24 and/or to another compatible function adapter 1.

With the aid of these coupling interfaces 23, current and/or control signals may be transmitted via the function adapter 1 to a function adapter 1 connected to the function adapter 1 and/or to a magnetic stirrer 2 which is equipped with the function adapter 1. The connection interfaces 21 in the interior of the receiving space 20 of the function adapter 1 are connected to the outer coupling interfaces 23 of the function adapter electrically and/or via signals.

In the exemplary embodiment of the function adapter 1 shown in FIGS. 6 and 7, this function adapter has a total of five stirring points 25 for driving a magnetic follower, for example a magnetic stirring bar, in each case. This function adapter 1 is designed to convert an existing single-point magnetic stirrer 2 into a multi-point magnetic stirrer and, moreover, to upgrade it with a heating function.

The function adapter 1 has five rotatably mounted outputs 26 as five stirring points 25 and a single magnetic coupling element 27. The magnetic coupling element 27 may be magnetically coupled to a stirring drive 28 of an existing magnetic stirrer 2 and serves to drive the outputs 26, functioning as stirring points 25, at least indirectly.

Each output 26 comprises two magnets 31, namely two rare-earth magnets, for magnetic coupling to a follower, for example to a magnetic stirring bar, which may be placed into a container 5 which is positioned on the supporting surface 4 on the supporting plate 6 of the function adapter 1.

FIG. 6 illustrates that the magnetic coupling element 27 is connected to the total of five outputs 26 of the function adapter 1 via distributors 29, namely via belts. In this way, a rotational movement of a stirring drive 28 of an existing magnetic stirrer 2 which is introduced into the function adapter 1 via the magnetic coupling element 27 may be distributed to the total of five rotatably mounted outputs 26 of the function adapter 1, which serve as stirring points of the function adapter 1.

In order to minimize or completely avoid magnetic shielding between the stirring points 25 of the function adapter 1 and magnetic followers, for example a magnetic stirring bar, the heat conducting layer 9 is interrupted and/or filled with a suitable, i.e. non-magnetically-shielding, inlay, for example a stainless steel inlay, and/or reduced in terms of its layer thickness, for example from 2 mm to 0.5 mm, 0.4 mm or even 0.3 mm, in at least one region, namely in the region of the stirring points 25 of the function adapter 1 or -in the case of the function adapter 1 shown in FIG. 8—n the region of a stirring point of the existing magnetic stirrer 2.

The view of the heating element 8 in FIG. 4 illustrates that the heating element 8 has a heatable surface 42, which is arranged or formed on the heating element 8 such that it is spaced apart from the heat conducting profile 11 in the usage position of the heating element 8 on the heat conducting profile 11. In this way, heat generated by the heatable surface 42 of the heating element 8 is prevented from being released directly to the heat conducting profile 11.

FIG. 4 furthermore illustrates that the heatable surface 42 of the heating element 8 is surrounded by an unheated edge region 33 of the heating element 8. This edge region 33 may be made from a mica material which has good heat-insulating properties and therefore counteracts a direct release of heat to the heat conducting profile 11. In the unheated edge region 33 of the heating element 8, the heating element 8 furthermore has material-free cutouts 34 at the edge. The material-free cutouts 34 adjoin the heatable surface 42 of the heating element 8. The provision of material-free cutouts 34 in the edge region 33 of the heating element 8 has the advantage that contact between the heating element 8 and the heat conducting profile 11 may be reduced or even completely avoided in these regions. Accordingly, the transfer of heat from the heatable surface 42 of the heating element 8 to the heat conducting profile 11 is minimized or even completely avoided at this point.

The heating element 8 may be supplied with current via a current connection 43.

The figures furthermore illustrate that a seal 37 is arranged between the supporting plate 6 and the heat conducting profile 11. The seal 37 has a circumferential sealing lip 38 facing the supporting plate 6 and prevents moisture from entering between the supporting plate 6 and the heat conducting profile 11.

The seal 37 is equipped with a series of light passage segments 39. The light passage segments 39 serve to define and form an effective light emission cross section of the light openings 18 of the heat conducting profile 11. In this way, it is possible to generate the light openings 18 in the heat conducting profile 11 using a cutter, for example. The use of a cutter gives the light openings 18 within the heat conducting profile 11 a certain, namely rounded, shape. If it is desirable for light segments 44 with an angular or rectangular shape to be generated on the supporting plate 6, this may be take place in a particularly simple manner via the correspondingly formed light passage segments 39 within the seal 37.

The seal 37, with its light passage segments 39, therefore serves as a shaping aperture which ultimately determines the shape of the light segments 44 on the supporting plate 6 of the function adapter 1.

In order to avoid a situation in which light is emitted laterally from a contact plane between the carrier plate 15 and the heat conducting profile 11, the heating plate structure 3 has a respective screen 36 for each light source 16 on the carrier plate 15. The screens 36 extend somewhat into the light openings 18 of the heat conducting profile 11 and avoid a situation in which the light sources 16 arranged within the screens 36 emit their light laterally through a possible gap between the carrier plate 15 and the heat conducting profile 11, which might disrupt the appearance of the function adapter 1.

The screens 36 may have a reflective coating, for example in the form of a white lacquer, and are designed so that they correspond to the angles of radiation from the light sources 16 and therefore do not interfere with light radiating upwards. This facilitates the formation of powerful light segments 44 as a light display 41 on the upper side of the supporting plate 6.

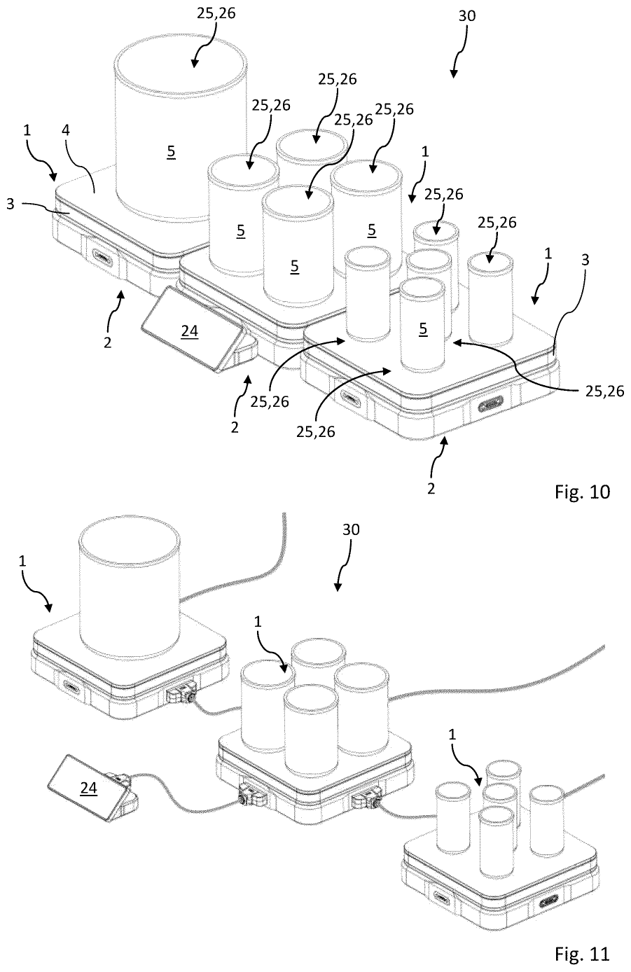

FIGS. 10 and 11 now show different magnetic stirrer arrangements 30, which comprise multiple magnetic stirrers 2 equipped with function adapters 1.

In the case of the magnetic stirrer arrangement 30 according to FIG. 10, the function adapters 1 are connected directly to each other via their housing-side coupling interfaces 23 and one of the function adapters 1 is connected to a control unit 24.

In the magnetic stirrer arrangement 30 according to FIG. 11, the connection of the function adapters 1 to each other and to a control unit 24 is realized via a wired connection.

All functions of the function adapters 1 and magnetic stirrers 2 which are combined to form a group may be controlled centrally via the control units 24.

FIG. 9 also shows a magnetic stirrer arrangement 30, which comprises a single magnetic stirrer 2, which is equipped with a function adapter 1. To activate the heating function of the function adapter 1 and the magnetic stirrer 2 arranged within the function adapter 1, a control unit 24 is connected to a coupling interface 23 of the function adapter 1 here.

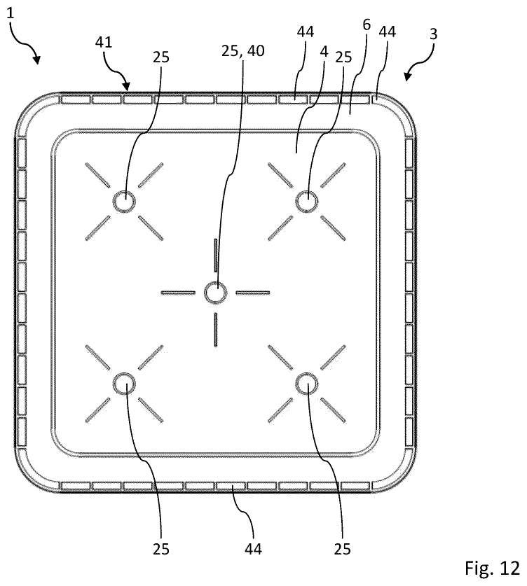

The function adapter 1 shown in FIG. 12 has a total of five stirring points 25, 40, wherein the stirring point denoted by 40 is a central stirring point 40, which is surrounded by four stirring points 25.

A large-volume container 5, as is used on the two function adapters 1 shown on the left in FIGS. 10 and 11, for example, may be positioned on the central stirring point 40.

However, as is the case for the function adapter 1 shown on the right in FIGS. 10 and 11 in each case, it is also possible to position a respective container 5 on each of the five stirring points 25, 40 in order to mix the liquids contained therein.

FIG. 12 also shows the light display 41 on the upper side of the supporting plate 6 adjacent to the supporting surface 4 of the supporting plate 6. The light display 41 consists of a series of light segments 44, which surround the heatable region of the supporting surface 4.

### List of Reference Signs

1 Function adapter
2 Magnetic stirrer
3 Heating plate structure
4 Supporting surface
5 Container
6 Supporting plate
7 Insulation layer
8 Heating element
9 Heat conducting layer
10 Tolerance compensation layer
11 Heat conducting profile
12 Adhesive tape
13 Interior space of 11
14 Heat shielding layer
15 Carrier plate
16 Light source
17 Data bus
18 Light opening
19 Housing of 1
20 Receiving space of 1
21 Connection interface in 20
22 Connection interface of 2
23 Coupling interface
24 Control unit
25 Stirring point on 1
26 Output on 1
27 Magnetic coupling element on 1
28 Stirring drive of 2
29 Distributor, belt
30 Magnetic stirrer arrangement
31 Magnet on 26
32 Fixing means
33 Unheated edge region of 8
34 Cutout in 33
35 Contact surface
36 Screen
37 Seal
38 Sealing lip
39 Light passage segment in 37
40 Central stirring point
41 Light display
42 Heatable surface of 8
43 Current connection
44 Light segment

1. A function adapter (1) for extending functionality of an existing magnetic stirrer (2), the function adapter (1) comprises:
a heating plate structure (3) with a heatable supporting surface (4) for at least one container (5).

2. The function adapter (1) as claimed in the claim 1, wherein the heating plate structure (3) has a supporting plate (6) made of glass ceramic, on which the supporting surface (4) is formed, an insulation layer (7), a heating element (8), and a heat conducting layer (9), wherein the heating element (8) is arranged between the supporting plate (6) and the insulation layer (7) and the insulation layer (7) is arranged between the heating element (8) and the heat conducting layer (9).

3. The function adapter (1) as claimed in claim 2, wherein the heating plate structure (3) has a tolerance compensation layer (10), between the insulation layer (7) and the heat conducting layer (9).

4. The function adapter (1) as claimed in claim 3, wherein the heating plate structure (3) has a heat conducting profile (11), which is connected to the heat conducting layer (9), and is arranged between the supporting plate (6) and the heat conducting layer (9).

5. The function adapter (1) as claimed in claim 4, wherein the heat conducting profile (11) at least one of is a closed circumferential profile, has a heat-dissipating design, or forms at least part of an outer contour of the heating plate structure (3).

6. The function adapter (1) as claimed in claim 5, wherein the supporting plate (6) is bonded to the heat conducting profile (11).

7. The function adapter (1) as claimed in claim 2, wherein the heating element (8) is at least one of arranged or designed such that only an inner region of the supporting plate (6), in which the supporting surface (4) is formed, is heatable.

8. The function adapter (1) as claimed in claim 2, wherein a heatable surface (19) of the heating element (7) is spaced apart from the heat conducting profile (11) and/or is surrounded by an unheated edge region (33) of the heating element (7), said edge region is made, of mica material, and/or wherein the heating element (7) has at least one material-free cutout (34) at the edge, which adjoins a heatable surface (19) of the heating element (7), and/or a respective contact surface in corner regions (35) of the heating element (7), via which the heating element (7) contacts the heat conducting profile (11) in a usage position.

9. The function adapter (1) as claimed in claim 2, 2 to 8, wherein the insulation layer (7) is made from a microporous insulation material, from polyurethane, rock wool and/or glass wool.

10. The function adapter (1) as claimed in claim 4, wherein the heat conducting profile (11) has a frame-shaped design and/or defines an interior space (13) in which at least one of the heating element (8), the insulation layer (7), or the tolerance compensation layer (10) is arranged.

11. The function adapter (1) as claimed in claim 2, wherein the heating plate structure (3) has a heat shielding layer (14) arranged on the heat conducting layer (9).

12. The function adapter (1) as claimed in claim 2, wherein the heating plate structure (3) has a carrier plate (15) of plastic, on an underside which faces away from the supporting plate (6).

13. The function adapter (1) as claimed in claim 4, wherein the function adapter (1) has at least one light source (16) for generating a light display (41) on the supporting plate (6).

14. The function adapter (1) as claimed in claim 13, wherein the at least one light source (16) is arranged on the heating plate structure (3), and for each said light source (16), the heating plate structure (3) has a respective screen (36) against lateral light radiation.

15. The function adapter (1) as claimed in claim 13, wherein, to generate the light display (41), the at least one light source (16) comprises multiple light sources (16) in the form of LEDs which are connected to each other via a data bus (17).

16. The function adapter (1) as claimed in claim 13, wherein the heat conducting profile (11) has at least one light opening (18), through which light from the at least one light source (16) is adapted be conducted to and through the supporting plate (6).

17. The function adapter (1) as claimed in claim 16, wherein the supporting plate (6) is designed to be at least one of partially transparent or translucent, knob-free, have a glass finish, a filter, or shading, at least in a region of the at least one light opening (18).

18. The function adapter (1) as claimed in claim 17, wherein a seal (37) is arranged between the supporting plate (6) and the heat conducting profile (11), the seal (37) has a sealing lip (38), which faces the supporting plate (6), and/or at least one light passage segment (39), which defines an effective light emission cross section of at least one light opening (18) of the heat conducting profile (11).

19. The function adapter (1) as claimed in claim 1, wherein the function adapter (1) is designed as an attachment to be seated on a supporting surface of a magnetic stirrer (2), and/or has a housing (19) with a receiving space (20) in which an existing magnetic stirrer (2) is arranged when the function adapter (1) is positioned in a usage position on the magnetic stirrer (2).

20. The function adapter (1) as claimed in claim 19, wherein the function adapter (1) has, in the receiving space (20), at least one fixing means (32) for fixing the function adapter (1) on a magnetic stirrer (2), and/or wherein a depth of the receiving space (20) corresponds to a height of the existing magnetic stirrer (2) or is greater than the height of the existing magnetic stirrer (2).

21. The function adapter (1) as claimed in claim 19, wherein the function adapter (1) has at least one connection interface (21), via which at least one of current, control signals, or data are adapted to be transferred between the function adapter (1) and the magnetic stirrer (2).

22. The function adapter (1) as claimed in claim 1, wherein the function adapter (1) has, on at least an outer side, at least one coupling interface (23) for at least one of mechanical, electrical, or data connection of the function adapter (1) to a control unit (24) and/or to another function adapter (1).

23. The function adapter (1) as claimed in claim 1, further comprising least one stirring point (25) for driving a magnetic follower.

24. The function adapter (1) as claimed in claim 23, further comprising, as the stirring point (25), at least one rotatably mounted output (26) and a magnetic coupling element (27), which is adapted to be magnetically coupled to a stirring drive (28) of a magnetic stirrer (2) and via which the at least one output (26) is adapted to be driven at least indirectly.

25. The function adapter (1) as claimed in claim 24, wherein the at least one output (26) has at least one magnet (31), for magnetic coupling to a follower.

26. The function adapter (1) as claimed in claim 25, wherein the at least one magnet (31) is a rare earth magnet.

27. The function adapter (1) as claimed in claim 26 26, further comprising at least two rotatably mounted outputs (26) as the stirring points (25), and the magnetic coupling element (27) is connected to the at least two outputs (26) via a distributor (29) so that a rotational movement introduced into the function adapter (1) via the magnetic coupling element (27) is adapted to be distributed to at least two rotatably mounted outputs (26) of the function adapter (1).

28. The function adapter (1) as claimed in claim 23, wherein the at least one stirring point includes stirring point (40), which is surrounded by at least two additional ones of the stirring points (25).

29. The function adapter (1) as claimed in claim 2, wherein the heat conducting layer (9) is interrupted and/or filled with a non-magnetically-shielding inlay and/or reduced in terms of a layer thickness thereof, in at least one region stirring in order to minimize or completely avoid magnetic shielding between a stirring point (25), and a magnetic follower.

30. A magnetic stirrer arrangement (30) comprising at least one magnetic stirrer (2) and at least one function adapter (1) as claimed in claim 23.
